(19) United States
(12) Patent Application Publication
(10) Pub. No.: US 2026/0091799 A1
(43) Pub. Date: Apr. 2, 2026

(54) SYSTEM AND METHOD FOR IDENTIFYING AND WARNING AGAINST IMPROPER VEHICLE LOADING

(71) Applicant: GM Global Technology Operations LLC, Detroit, MI (US)

(72) Inventors: Avesta Goodarzi, Whitby (CA); Utkarsh Saini, Pickering (CA); Steffen Peter Lindenthal, Oshawa (CA)

(21) Appl. No.: 18/904,515

(22) Filed: Oct. 2, 2024

(51) Int. Cl. B60W 50/14; B60W 40/13

(52) U.S. Cl. CPC B60W 50/14; B60W 40/13; B60W 2420/403; B60W 2530/10

(57) ABSTRACT

A method for method for identifying and warning against improper vehicle loading is provided. The method includes obtaining camera images from at least one camera of a vehicle having a payload; performing image processing for the camera images, via a processor of the vehicle; determining a suspension deflection estimation via the processor; determining a payload estimation and a payload center of gravity estimation, via the processor, using the suspension deflection estimation; and providing a warning, based on the payload estimation and the center of gravity estimation, to a user of the vehicle if the payload estimation and center of gravity estimation indicates at least one of that the payload is unbalanced or that the payload exceeds a threshold. The at least one camera includes a front-view camera, a right-side view camera, and a left-side view camera.

### INTRODUCTION

The present disclosure relates to a vehicle, and more particularly, to a method for identifying and warning a user of the vehicle of improper vehicle loading.

Some vehicles are equipped to carry a payload and other cargo. However, some of these vehicles may be improperly loaded through overloading or loading the vehicle with an unbalanced payload. An overloaded vehicle or a vehicle with an unbalanced load (i.e., an improper center of gravity) can be unstable, difficult to control, and/or damaged structurally.

Thus, while present vehicles for carrying a payload may achieve their intended purpose, there is a need for a new and improved vehicle that assists a user in avoiding an improperly loaded payload.

### SUMMARY

According to several aspects of the present disclosure, a method for identifying and warning against improper vehicle loading is provided. The method includes obtaining camera images from at least one camera of a vehicle having a payload; performing image processing for the camera images, via a processor of the vehicle; determining a suspension deflection estimation via the processor; determining a payload estimation and a payload center of gravity estimation, via the processor, using the suspension deflection estimation; and providing a warning, based on the payload estimation and the center of gravity estimation, to a user of the vehicle if the payload estimation and center of gravity estimation indicates at least one of that the payload is unbalanced or that the payload exceeds a threshold. The at least one camera includes a front-view camera, a right-side view camera, and a left-side view camera.

In accordance with another aspect of the disclosure, obtaining camera images includes using at least one of Inertial Measurement Unit (IMU) data to determine if the vehicle is substantially level or vehicle speed to determine if the vehicle is parked, and, if substantially level and parked, enabling the processor to perform image processing

In accordance with another aspect of the disclosure, the at least one camera includes a rear-view camera and a center high-mounted stop lamp (CHMSL) camera.

In accordance with another aspect of the disclosure, obtaining camera images includes obtaining camera images of at least one of ground beneath or surrounding the vehicle.

In accordance with another aspect of the disclosure, determining a suspension deflection estimation includes using at least one determined camera height from the performing image processing step.

In accordance with another aspect of the disclosure, determining a suspension deflection estimation includes using known vehicle dimensions.

In accordance with another aspect of the disclosure, determining a payload estimation and a payload center of gravity estimation includes using vehicle suspension rates to calculate the payload and center of gravity estimation.

In accordance with another aspect of the disclosure, providing a warning includes using at least one of a wheel load, a payload weight, or an estimated payload center of gravity to calculate warning to the user.

In accordance with another aspect of the disclosure, the estimated payload center of gravity includes a longitudinal position and a lateral position.

In accordance with another aspect of the disclosure, the method further includes calculating a recommended location for repositioning the payload to provide to the user.

In accordance with another aspect of the disclosure, the method further includes calculating a recommended payload reduction amount to provide to the user.

According to several aspects of the present disclosure, a system is provided. The system includes one or more cameras for a vehicle having a payload and configured to obtain camera images beneath or surrounding the vehicle, the one or more cameras including a front-side camera, a right-side camera, and a left-side camera; one or more human-machine interfaces (HMIs) disposed within the vehicle; and a controller for the vehicle. The controller includes a processor and is coupled to the one or more cameras and the one or more human-machine interfaces (HMIs). The controller is configured to at least facilitate performing image processing for the camera images; determining a suspension deflection estimation via the processor; determining a payload estimation and a payload center of gravity estimation, via the processor, using the suspension deflection estimation; and providing a warning, based on the payload estimation and the payload center of gravity estimation, to a user of the vehicle if the payload estimation and payload center of gravity estimation indicates at least one of that the payload is unbalanced within the vehicle or that the payload exceeds a threshold.

In accordance with another aspect of the disclosure, the one or more cameras includes a front-view camera, a rear-view camera, a right-side view camera, a left-side view camera, and a center high-mounted stop lamp (CHMSL) camera.

In accordance with another aspect of the disclosure, the processor is configured to facilitate obtaining camera images using at least one of Inertial Measurement Unit (IMU) data or vehicle speed, and the processor is configured to facilitate determining if the vehicle is parked and substantially level based at least partially on the Inertial Measurement Unit (IMU) data or vehicle speed, and, if parked and substantially level, the processor is configured to facilitate enabling the processor to perform image processing.

In accordance with another aspect of the disclosure, determining a suspension deflection estimation includes using at least one determined camera height from the performing image processing step.

In accordance with another aspect of the disclosure, determining a payload estimation and a payload center of gravity estimation includes using vehicle suspension rates to calculate the payload and center of gravity estimation.

In accordance with another aspect of the disclosure, providing a warning includes using at least one of a wheel load, a payload weight, or an estimated payload center of gravity to calculate warning to the user.

In accordance with another aspect of the disclosure, the estimated payload center of gravity includes a longitudinal position and a lateral position.

In accordance with another aspect of the disclosure, providing a warning includes at least one of calculating a recommended location for repositioning the payload to provide to the user or calculating a recommended payload reduction amount to provide to the user.

According to several aspects of the present disclosure, a vehicle is provided. The vehicle includes a body, one or more cameras configured to obtain camera images under and surrounding the body, and a processor coupled to the one or more cameras. The one or more cameras includes a front-view camera, a right-side camera, and a left-side camera. The processor is configured to at least facilitate performing image processing for the camera images; determining a suspension deflection estimation via the processor; determining a payload estimation and a payload center of gravity estimation, via the processor, using the suspension deflection estimation; and providing a warning, based on the payload estimation and the payload center of gravity estimation, to a user of the vehicle if the payload estimation and the center of gravity estimation indicates at least one of that the payload is unbalanced within the vehicle or that the payload exceeds a threshold.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a side perspective view illustrating an exemplary vehicle having a payload and a system for identifying and warning against improper vehicle loading, in accordance with the present disclosure.

FIG. 2 is a schematic diagram of the system for identifying and warning against improper vehicle loading in the vehicle shown in FIG. 1, in accordance with the present disclosure.

FIG. 3 is a flowchart illustrating a method for identifying and warning against improper vehicle loading used by the system shown in FIG. 2, in accordance with the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. The following description is merely exemplary in nature and is not intended to limit the present disclosure, application, or uses.

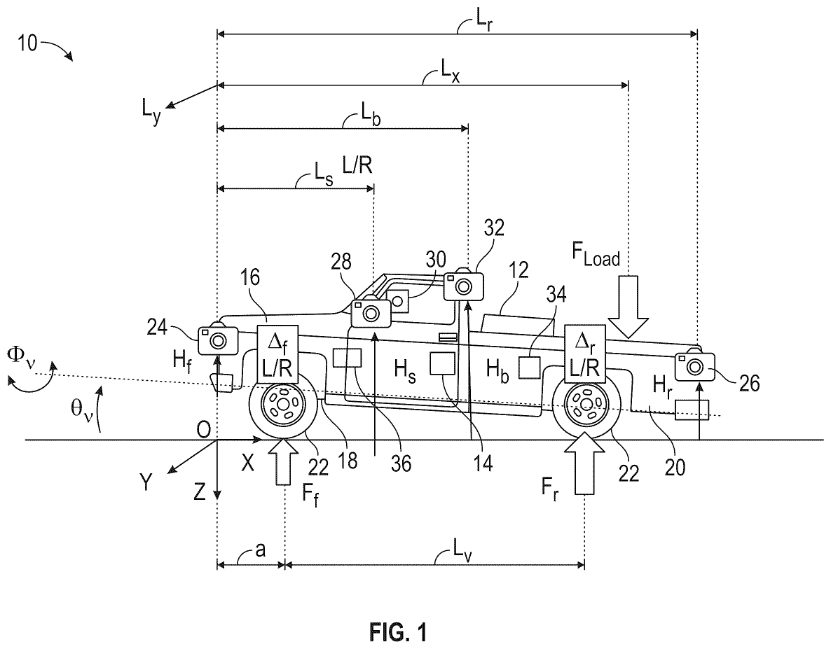

FIG. 1 illustrates a vehicle 10, a payload 12 contained by the vehicle 10, and a payload analysis system 14. The vehicle 10 is configured to carry the payload 12 when being operated by a user. In general, the vehicle 10 includes an automobile and more preferably, a pickup-type truck. However, the vehicle 10 may be any one of a number of different types of automobiles, for example a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles. In some examples, the vehicle 10 may also comprise a motorcycle or other vehicle, such as aircraft, spacecraft, watercraft, and so on, and/or one or more other types of mobile platforms (e.g., a robot and/or other mobile platform).

As depicted in FIG. 1, the vehicle 10 includes a body 16 that is arranged on a chassis 18. The body 16 may include a vehicle bed 20 and may substantially enclose other components of the vehicle 10. The vehicle 10 also includes a plurality of wheels 22 and a drive system (not shown) for the wheels 22 and vehicle 10. The wheels 22 are each rotationally coupled to the chassis 18 near a respective corner of the body 16 to facilitate movement of the vehicle 10. In one embodiment, the vehicle 10 includes four wheels 22, although this may vary in other embodiments (for example for trucks and certain other vehicles).

As depicted in FIG. 1, the vehicle 10 includes at least one camera disposed on the body 16. For example, the at least one camera includes a front-view camera 24, a rear-view camera 26, and/or multiple side-view cameras (e.g., a driver-side camera 28, a passenger-side camera 30, and the like). The front-view camera 24 is coupled to a front of the vehicle 10 and is configured to provide a clear view of an area surrounding the front of the vehicle 10. The rear-view camera 26 is coupled to a rear portion of the body 16 and is configured to provide a clear view of an area surrounding the rear of the vehicle 10. The rear-view camera 26 may be multi-functional and may also be configured to assist a user in backing the vehicle 10. The driver-side camera 28 may be mounted to a driver side portion of the body 16, for example on or integral with a driver side-view mirror. The passenger-side camera 30 may be mounted to a passenger side portion of the body 16, for example on or integral with a passenger side-view mirror. In some instances, the vehicle 10 may include a center high-mounted stop lamp (CHMSL) camera 32. The CHSML camera 32 may include a camera integrated into a center high mounted stop lamp (or third brake light) and may provide a clear view of a bed of the vehicle 10 and/or an area surrounding the rear of the vehicle 10. Each camera may be configured with night-vision, a wide-angle view, wireless networking technology (e.g., built-in Wi-Fi and/or global positioning system (GPS) capability), and/or waterproof capability.

In addition, and in various embodiments, the vehicle 10 may include one or more other sensors 34. For example, the other sensors 34 may include one or more inertial measurements unit (IMU) sensors that provide inertial measurement (IMU) data, detection sensors (e.g., other cameras, Lidar, sonar, radar, or the like), and/or one or more other sensors configured to obtain sensor data as to one or more other parameters pertaining to the vehicle 10, operation thereof, and/or the environment of the vehicle 10, for example a slope of the roadway and various parameters as to the cameras (e.g., installation position and orientation of the cameras, for example pitch, roll, and a heading, pixel size, number of pixels, and/or focal length of the cameras).

With continuing reference to FIG. 1, the vehicle 10 further includes a human-machine interface (HMI) 36 disposed within the vehicle 10 to interact with an operator of the vehicle 10. The HMI 36 is in communication with the system 14. In several aspects, the HMI 36 includes one or more devices capable of interacting with the operator, such as a screen disposed within the vehicle 10 such as an instrument cluster, an infotainment screen, a heads-up display (HUD), an interior rear-view screen such as a rear-view mirror augmented by a screen, a sound delivery system, speakers, a microphone, or the like. However, it should be appreciated that other HMIs 36 are considered herein as well. For example, the HMI 36 may be a mobile device, such as a tablet computer, a mobile phone, a cell phone in communication with an application (e.g., PAA 38), or the like, and the HMI 36 may be provided by the operator and temporarily mounted to or disposed on an interior passenger compartment component of the vehicle 10.

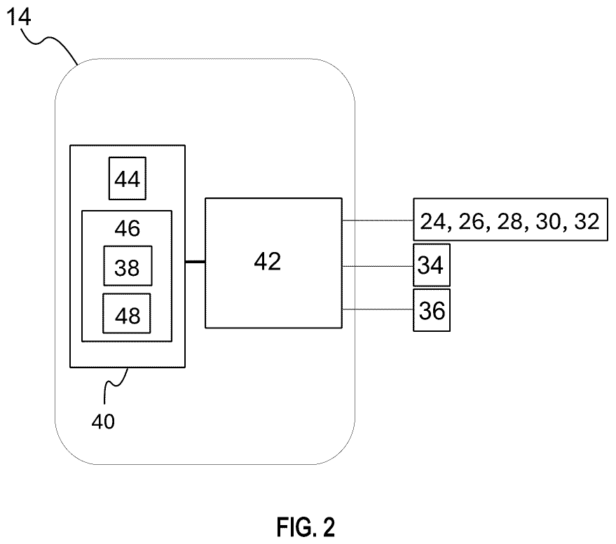

Referring to FIG. 2, a schematic diagram of the payload analysis system 14 is illustrated. The payload analysis system 14 is configured for identifying and warning against improper vehicle loading. The payload analysis system 14 includes a controller 40 and an interface circuit 42.

The controller 40 is used to implement a method 100 for identifying and warning against improper vehicle loading, as will be described below. In various embodiments, the controller 40 (and, in certain embodiments, the payload analysis system 14 itself) is disposed within and/or mounted to the body 16 or chassis (not shown) of the vehicle 10. In certain embodiments, the controller 40 and/or payload analysis system 14 and/or one or more components thereof may be disposed outside the body 16, for example on a remote server, in the cloud, or other device where image processing is performed remotely. It will be appreciated that the controller 40 may otherwise differ from the embodiment depicted in FIG. 1. For example, the controller 40 may be coupled to or may otherwise utilize one or more remote computer systems and/or other control systems, for example as part of one or more of the above-identified vehicle 10 devices and systems. The controller 40 includes at least one processor 44 and a non-transitory computer readable storage device or memory 46.

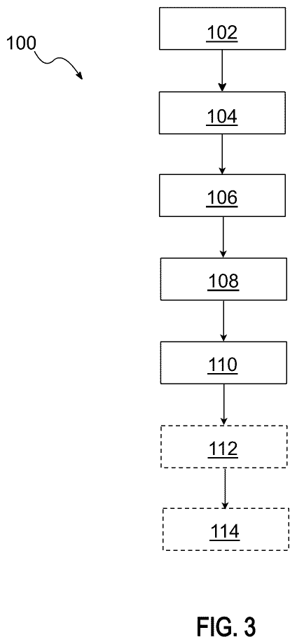

The processor 44 performs the computation and control functions of the controller 40 and may comprise any type of processor or multiple processors, single integrated circuits such as a microprocessor, or any suitable number of integrated circuit devices and/or circuit boards working in cooperation to accomplish the functions of a processing unit. During operation, the processor 44 executes one or more programs or applications 48 contained within the memory 46 and controls the general operation of the controller 40 and the computer system of the controller 40, generally in executing the processes described herein, such as the method 100 of FIG. 3. The processor 44 may be a custom made or commercially available processor, a central processing unit (CPU), a graphics processing unit (GPU), an auxiliary processor among several processors associated with the controller 40, a semiconductor-based microprocessor (in the form of a microchip or chip set), a macroprocessor, a field programmable gate array (FPGA), an application specific integrated circuit (ASIC), a combination thereof, or generally a device for executing instructions.

The computer readable storage device or memory 46 may include volatile and nonvolatile storage in read-only memory (ROM), random-access memory (RAM), dynamic random access memory (DRAM) such as SDRAM, and keep-alive memory (KAM), for example. KAM is a persistent or non-volatile memory that may be used to store various operating variables while the processor 44 is powered down. The computer-readable storage device or memory 46 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions used by the controller 40 to control the payload analysis system 14. In certain examples, the memory 46 is located on and/or co-located on the same computer chip as the processor 44. In the depicted embodiment, the memory 46 stores the program along with one or more stored values, including for identification and warning against improper loading of the vehicle 10 based on the processing of the sensor data that is obtained from the cameras 24, 26, 28, 30 and/or the sensors 34.

The controller 40 further includes one or more applications 48. An application 48 includes a software program configured to perform a specific function or set of functions. The application 48 may include one or more computer programs, software components, sets of instructions, procedures, functions, objects, classes, instances, related data, or a portion thereof adapted for implementation in a suitable computer readable program code. The application 48 may be stored within the memory 46 or in additional or separate memory. Examples of applications 48 include audio or video streaming services, games, browsers, social media, suspension and engine control programs, body control programs, advanced driver assistance system (ADAS) programs, and the like. In a particular application 48 of the present disclosure, the system 14 includes the payload analysis application (PAA) 38.

For example, the PAA 38 in combination with other vehicle control applications may assist a vehicle operator in loading the vehicle 10 with a payload by providing verbal (e.g., via a vehicle speaker) or visual instruction (e.g., via HMI 36 and the like) to the operator. The verbal and/or visual assistance can be configured by an operator in the HMI 36 or an application (e.g., OnStar) in-vehicle. More specifically, the PAA 38 includes a plurality of sub-routines or instructions that are stored in memory 46 of the controller 40 and executed by the processor 44 while data is received, via the interface circuit 42, from the sensors 34 such as the vehicle cameras, and/or IMUs. The PAA 38 further includes a plurality of subroutines or instructions that cause data to be transmitted from the controller 40 to the HMI 36.

The controller 40 may also consist of multiple controllers which are in electrical communication with each other. The controller 40 further may include additional elements and/or modules, such as, for example, a real-time clock (RTC) module for measuring the passage of real-time. In an exemplary embodiment, the controller 40 is powered by connection to a battery cell or other power source.

The controller 40 is in electrical communication with the interface circuit 42. In an exemplary embodiment, the electrical communication is established using, for example, general purpose input/output (GPIO) pins, an inter-integrated circuit (I2C) bus, a serial peripheral interface (SPI) bus, a parallel communication bus, direct hard-wired connections, fiber optics, infrared and wireless bus technologies, or the like. It should be understood that various additional communication protocols for communicating with the controller 40 are within the scope of the present disclosure.

The interface circuit 42 is used to interface the controller 40 with the cameras (e.g., front-view camera 24, rear-view camera 26, side view cameras 28, 30, and/or CHSML camera 32) and/or the HMI 36. The interface circuit 42 allows communication to the computer system of the controller 40, for example from a system driver and/or another computer system and can be implemented using any suitable method and apparatus. In one embodiment, the interface circuit 42 obtains the various data from the sensors 34 and/or the cameras, among other possible data sources. The interface circuit 42 can include one or more network interfaces to communicate with other systems or components. The interface circuit 42 may also include one or more network interfaces to communicate with technicians, and/or one or more storage interfaces to connect to storage apparatuses.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 44) to perform and execute the program. Such a program product may take a variety of forms, and the present disclosure applies equally regardless of the particular type of computer-readable signal bearing media used to carry out the distribution. Examples of signal bearing media include recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 40 may also otherwise differ from the embodiment depicted in FIG. 2, for example in that the computer system of the controller 40 may be coupled to or may otherwise utilize one or more remote computer systems and/or other control systems.

With reference to FIG. 3, a flowchart of method 100 of the PAA 38 is illustrated, in accordance with the present disclosure. The method starts at block 102 when one or more specific conditions occur. The specific conditions may include manual initialization by the operator via the HMI 36 or the operation of a physical button disposed in the interior of the vehicle 10. In further examples, the conditions may be automatically satisfied by sensors 34 and/or the cameras 24, 26, 28, 30, 32.

Block 102 depicts obtaining camera images from at least one camera 24, 26, 28, 30, 32 of the vehicle 10 having a payload 12. The system 14 and the interface circuit 42 receive the camera images from the at least one camera 24, 26, 28, 30, 32. The at least one camera includes the front-view camera 24, the rear-view camera 26, the right-side view (or passenger-side) camera 30, and the left-side view (or driver-side) camera 28. When used, the interface circuit 42 can receive camera images from the CHSML camera 32. Preferably, the system 14 and the interface circuit 42 receive camera images at least from the front-view camera 24, the right-side view camera 30, and the left-side view camera 28 to estimate vehicle pitch and vehicle roll angles for calculating four suspension deflections. However, increased accuracy is obtained when obtaining camera images from all cameras 26, 26, 28, 30, and 32. In some instances, obtaining the camera images may include determining that the vehicle 10 is stationary and substantially level (i.e., the vehicle 10 is parked on a substantially flat and level surface (within ±5°)) using information including vehicle speed, which may be received from the HMI 36 or the vehicle 10, and/or from, for example, an IMU sensor configured to measure a specific force, angular rate, and/or orientation of the vehicle 10 (i.e., whether the vehicle 10 is substantially level within ±5°). If the vehicle 10 is located on an uneven surface, subsequent payload estimation and payload center of gravity estimation may not be accurate. When the vehicle 10 is determined to be stationary and substantially level, the system 14 and/or the controller 40 may enable method 100 and the obtaining camera images step in block 102.

Block 104 depicts performing image processing the camera images via the controller 40 and processor 44 of the vehicle 10. Image processing may include image enhancement, image restoration, image compression, image segmentation, and/or object detection and classification of the camera images. Image processing may also include filtering, edge detection, and/or morphological processing of the camera images. Additionally, image processing may include determining a height of each camera (e.g., front-view camera H_{f}, rear-view camera Hᵣ, right-side view camera Hₛᵣ, left-side view camera Hₛₗ, CHMSL camera H_{b}, and so forth). Determining the height of each camera may include, for example, calculating a ratio of pixels to a known measurement, using a depth-sensing camera that provides distance information for each pixel allowing for accurate height estimation, and/or segmentation to estimate height based on segmented portions. Further, in some instances, performing image processing may include using machine learning and/or artificial intelligence (AI) such as training a convolutional neural network (CNN) or a four-stage developing network to recognize and estimate height from obtained camera images. It will be appreciated that processing the camera images may include using other suitable techniques and/or algorithms.

For example, the processor 44 can determine heights of each camera Z to obtain vehicle vertical movement estimation ΔZ using a longitudinal location X, a known curb weight height Z₀, an estimated height Z from the camera images and can use ΔZ to determine a pitch angle estimation θ_{vc} and a roll angle estimation φ_{vc}. A pitch angle estimation can be determined using the following formula, where ΔZ is vehicle vertical movement estimation, x is horizontal distance (i.e., from a front of the vehicle 10), θ_{vc} is the pitch angle, and ΔZᵥ is an additional vertical displacement.

$$Δ Z = x tan {θ}_{vc} + Δ {Z}_{v}$$

A roll angle can be determined using the following formula, where φ_{vc} is the roll angle, ΔHₛₗ is a height difference on a left side of the vehicle 10, ΔHₛᵣ is a height difference of a right side of the vehicle 10, and Dy is a distance between the two points where the height differences are measured.

$${ϕ}_{vc} = \frac{Δ {H}_{sl} - Δ {H}_{sr}}{{D}_{y}}$$

Block 106 depicts determining a suspension deflection estimation via the processor 44. Suspension deflection estimation is a crucial aspect of vehicle dynamics and safety and involves measuring how much the suspension system compresses or extends under various loads and conditions, for example the payload 12. In an example, the processor 44 can use known vehicle dimensions and information received from the processed camera images, such as camera heights (Hᵣ, Hᵣ, Hₛᵣ, Hₛₗ, H_{b}, and so forth) or specific height of a portion of the vehicle 10 (e.g., front right, front left, rear right, rear left), to estimate the suspension deflection(s) and force. For example, load estimation ΔF of (or force from the payload on) each wheel 22 of the vehicle 10 can be determined by using known vehicle suspension rates (K_{fL}, K_{fR}, K_{rL}, K_{rL}) and the estimated vehicle pitch angle θ_{vc}, roll angle φ_{vc}, and vertical movement ΔZᵥ, as shown by the following equations for determining front left load estimation ΔF_{fL}, front right load estimation ΔF_{fR}, rear left load estimation ΔF_{rL}, and rear right load estimation ΔF_{rR}, (or “wheel loads”) where a is a distance between the front camera 24 and a location where the front wheel 22 of the vehicle 10 contacts ground, and where Lᵥ is a distance between the wheels 22.

$$\begin{matrix}Δ {F}_{fL} = ( a tan {θ}_{v} + Δ {Z}_{v} + \frac{Dy}{2} {ϕ}_{vc} ) {K}_{fL} \\ Δ {F}_{fR} = ( a tan {θ}_{v} + Δ {Z}_{v} - \frac{Dy}{2} {ϕ}_{vc} ) {K}_{fR} \\ Δ {F}_{rL} = ( ( a + {L}_{v} ) tan {θ}_{v} + Δ {Z}_{v} + \frac{Dy}{2} {ϕ}_{vc} ) {K}_{rL} \\ Δ {F}_{rR} = ( ( a + {L}_{v} ) tan {θ}_{v} + Δ {Z}_{v} + \frac{Dy}{2} {ϕ}_{vc} ) {K}_{rR}\end{matrix}$$

Block 108 depicts determining a payload estimation and a payload center of gravity estimation, via the processor, using the suspension deflection estimation and the load estimations for each wheel or portion of the vehicle 10. For example, the processor 44 can determine the payload estimation F_{Load} using the following formula.

$${F}_{Load} = Δ {F}_{fL} + Δ {F}_{fR} + Δ {F}_{rL} + Δ {F}_{rR}$$

Additionally, the processor 44 can determine the payload center of gravity (CG) estimation using the following formulas, where Lₓ is a longitudinal position of the payload center of gravity and L_{y} is a lateral position of the payload center of gravity.

$$\begin{matrix}{L}_{x} = a + \frac{Δ {F}_{rL} + Δ {F}_{fR}}{{F}_{Load}} {L}_{v} \\ {L}_{y} = \frac{Δ {F}_{rL} + Δ {F}_{fL}}{{F}_{Load}} {D}_{y}\end{matrix}$$

Block 110 depicts providing a warning, based on the load estimation F_{Load} and center of gravity estimation Lₓ, L_{y} to a user of the vehicle 10, which may be determined as a parked vehicle, if the load F_{Load} estimation and center of gravity estimation Lₓ, L_{y} indicates at least one of that the payload 12 is unbalanced or that the payload 12 exceeds a threshold. For example, when the processor 44 and/or the controller 40 determines that a payload 12 is unbalanced and/or the payload 12 exceeds a threshold (e.g., weight threshold, balance threshold), the controller 40 and interface circuit 42 can send a warning to the HMI 36 and indicate (e.g., text, verbal, and the like) to a user of the vehicle 10 that the payload 12 is unbalanced and/or exceeds a threshold.

Optional Block 112 depicts calculating a recommended location for repositioning the payload 12 to provide to the user of the vehicle 10. In some instances, the controller 40 may indicate, via an HMI 36, to the user of the vehicle 10 the recommended location (e.g., lateral, longitudinal) for repositioning the payload 12 to safely balance the payload 12.

Optional block 114 depicts calculating a recommended payload reduction amount to provide to the user of the vehicle 10. In some instances, the controller 40 may indicate, via an HMI 36, to the user of the vehicle 10 the recommended amount of payload weight reduction to a predetermined safe weight.

The method, system, and vehicle of the present disclosure includes many advantages. The method, system, and vehicle are configured to identify and warn a vehicle user against an overloaded vehicle or a vehicle with an unbalanced load (i.e., an improper center of gravity). Operating a vehicle with a payload that is overloaded and/or unbalance can lead to vehicle instability, vehicle control difficulty, and/or a structurally damaged vehicle.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for identifying and warning against improper vehicle loading, comprising:
obtaining camera images from at least one camera of a vehicle having a payload, wherein the at least one camera includes a front-view camera, a right-side view camera, and a left-side view camera;
performing image processing for the camera images, via a processor of the vehicle;
determining a suspension deflection estimation via the processor;
determining a payload estimation and a payload center of gravity estimation, via the processor, using the suspension deflection estimation; and
providing a warning, based on the payload estimation and the center of gravity estimation, to a user of the vehicle if the payload estimation and center of gravity estimation indicates at least one of that the payload is unbalanced or that the payload exceeds a threshold.

2. The method of claim 1, wherein obtaining camera images includes using at least one of Inertial Measurement Unit (IMU) data to determine if the vehicle is substantially level or vehicle speed to determine if the vehicle is parked, and, if the vehicle substantially level and parked, enabling the processor to perform image processing.

3. The method of claim 1, wherein the at least one camera includes a rear-view camera and a center high-mounted stop lamp (CHMSL) camera.

4. The method of claim 1, wherein obtaining camera images includes obtaining camera images of at least one of ground beneath or surrounding the vehicle.

5. The method of claim 1, wherein determining a suspension deflection estimation includes using at least one determined camera height from the performing image processing step.

6. The method of claim 1, wherein determining a suspension deflection estimation includes using known vehicle dimensions.

7. The method of claim 1, wherein determining a payload estimation and a payload center of gravity estimation includes using vehicle suspension rates to calculate the payload and center of gravity estimation.

8. The method of claim 1, wherein providing a warning includes using at least one of a wheel load, a payload weight, or an estimated payload center of gravity to calculate warning to the user.

9. The method of claim 8, wherein the estimated payload center of gravity includes a longitudinal position and a lateral position.

10. The method of claim 1, further comprising:
calculating a recommended location for repositioning the payload to provide to the user.

11. The method of claim 1, further comprising:
calculating a recommended payload reduction amount to provide to the user.

12. A system, comprising:
one or more cameras for a vehicle having a payload and configured to obtain camera images beneath or surrounding the vehicle, the one or more cameras including a front-side camera, a right-side camera, and a left-side camera;
one or more human-machine interfaces (HMIs) disposed within the vehicle; and
a controller for the vehicle, the controller including a processor, wherein the controller is coupled to the one or more cameras and the one or more human-machine interfaces (HMIs) and is configured to at least facilitate
performing image processing for the camera images;
determining a suspension deflection estimation via the processor;
determining a payload estimation and a payload center of gravity estimation, via the processor, using the suspension deflection estimation; and
providing a warning, based on the payload estimation and the payload center of gravity estimation, to a user of the vehicle if the payload estimation and payload center of gravity estimation indicates at least one of that the payload is unbalanced within the vehicle or that the payload exceeds a threshold.

13. The system of claim 12, wherein the one or more cameras includes a front-view camera, a rear-view camera, a right-side view camera, a left-side view camera, and a center high-mounted stop lamp (CHMSL) camera.

14. The system of claim 12, wherein the processor is configured to facilitate obtaining camera images using at least one of Inertial Measurement Unit (IMU) data or vehicle speed, and the processor is configured to facilitate determining if the vehicle is parked and substantially level based at least partially on the Inertial Measurement Unit (IMU) data or vehicle speed, and, if parked and substantially level, the processor is configured to facilitate enabling the processor to perform image processing.

15. The system of claim 12, wherein determining a suspension deflection estimation includes using at least one determined camera height from the performing image processing step.

16. The system of claim 12, wherein determining a payload estimation and a payload center of gravity estimation includes using vehicle suspension rates to calculate the payload and center of gravity estimation.

17. The system of claim 12, wherein providing a warning includes using at least one of a wheel load, a payload weight, or an estimated payload center of gravity to calculate warning to the user.

18. The system of claim 17, wherein the estimated payload center of gravity includes a longitudinal position and a lateral position.

19. The system of claim 12, wherein providing a warning includes at least one of calculating a recommended location for repositioning the payload to provide to the user or calculating a recommended payload reduction amount to provide to the user.

20. A vehicle comprising
a body;
one or more cameras configured to obtain camera images under and surrounding the body, the one or more cameras including a front-view camera, a right-side camera, and a left-side camera; and
a processor coupled to the one or more cameras and configured to at least facilitate:
performing image processing for the camera images;
determining a suspension deflection estimation via the processor;
determining a payload estimation and a payload center of gravity estimation, via the processor, using the suspension deflection estimation; and
providing a warning, based on the payload estimation and the payload center of gravity estimation, to a user of the vehicle if the payload estimation and the center of gravity estimation indicates at least one of that the payload is unbalanced within the vehicle or that the payload exceeds a threshold.
